(19) United States
(12) Patent Application Publication
(10) Pub. No.: US 2002/0122391 A1
(43) Pub. Date: Sep. 5, 2002

(54) Method and system for providing audio conferencing services to users of on-line text messaging services

(76) Inventor: Andrew L. Shalit, Brookline, MA (US)

Correspondence Address: Clifford Chance Rogers & Wells LLP, 200 Park Avenue, New York, NY, 10166-0153, US

(21) Appl. No.: 10/028,034

(22) Filed: Dec. 21, 2001

Related U.S. Application Data
(60) Provisional application No. 60/261,347, filed on Jan. 12, 2001.

(51) Int. Cl. H04L 12/16

(52) U.S. Cl. 370/260; 370/259

(57) ABSTRACT

A method and system for providing audio conferencing services to users of an on-line text messaging service connected for text messaging over a computer network. A voice communication telephone number and identification code is provided to selected users instructing the selected users to call the telephone number using a telephone network and enter the identification code. When they call in, a conference call is set up, including the at least two selected users, whereby the selected users can communicate orally over the telephone network without revealing their telephone numbers.

### BACKGROUND OF THE INVENTION

The present invention relates to a method and system for providing audio conferencing services, and in particular, for providing audio conferencing services to users of online text messaging services.

The present invention is a system and method for providing audio conferencing services to users of on-line text messaging services over a computer network, preferably a global computer network, and most preferably, over the Internet. The invention is also very useful over intranets and other company/organization internal networks.

People communicate over their computers using text chat and instant messaging services. These text chat and instant messaging services are used over computer networks, global computer networks, and in particular, over the Internet, to allow people to communicate with each other instantaneously.

Often people who are communicating with each other, either over a chat line or an instant messaging connection, want to speak to each other. At present, it is difficult to do this on a spontaneous and informal basis without divulging personal information, for example, a telephone number. It is also difficult to carry out voice communication on a spontaneous and informal basis in groups greater than two persons.

Participants in an online environment who desire to speak with one another typically must share such information (telephone numbers, email addresses) while actively participating. The desire for secure, anonymous, spontaneous generation of teleconferencing from the list of active participants in online collaborative situations represents an area of innovation yet untapped by conventional technologies.

Among the ways that people communicate with others via global computer networks, and in particular, the Internet, is to participate in chat or instant messaging, wherein text is delivered instantaneously between or among the various participants. Some such systems are illustrated in FIG. 1.

FIG. 1 illustrates a text-messaging and chat system. The system includes two or more computers 2A through 2N with installed text messaging client software 2A1 through 2N1 connected to a network such as the Internet 3. Also connected to Internet 3 is an Internet portal 7 with a text messaging server 7A, an Internet service provider 6 with a text messaging session server 6B and a text messaging login server 6A, and a web server 5 (further described with regard to FIG. 2).

One form of chat communication on the Internet is Internet relay chat, which runs on a client-server model with a network of distributed servers. Accordingly, computer 2A will have text messaging client software 2A1 and computer 2N will have text messaging client software 2N1 which enables the users of computer 2A and computer 2N to text communicate via chat lines. When the user of the computer wants to chat, the user makes a connection to the Internet 3 and starts the client software. The user then logs onto an Internet relay chat server, for example, the server 7A for Internet portal 7 or server 6B of an Internet service provider 6. There are many Internet relay chat servers located all over the world and are connected together via the Internet, so they can relay messages among one another. When the user is connected to a server, the user then selects a specific channel or chat group to join and chooses a user name to identify the user when the user is chatting. After the user has joined a channel, the user is able to see conversations that are taking place on the user's screen by scrolling text. The user can join the conversation by typing a message in on the user's keyboard. The message is sent from the client's software 2A1 on the computer to the server, and the message is sent from the server to other servers where the people on the same channel are logged on. The message gets sent from server to server and is received by the client software 2N1 of computer 2N also connected to that channel on any one of the servers.

In instant messaging, for example the popular Instant Messenger service of America On-line, the user of computer 2A or 2N runs a piece of client software while connected to the Internet. When that software is run, it opens up a TCP connection to an instant messenger login server 6A which sends the screen name and password over the connection to log the user into the server. The server checks the screen name and password, and if they are correct, the login server instructs the instant messenger software to close the connection to the login server and open a new connection to a text messaging session server 6B that handles the instant message session. This connection uses a communications protocol that allows for instant messaging functionality. Instant messaging software also includes buddy list capabilities. This means that the user keeps a list of people who the user would like to send instant messages to, and when they come online, the user is notified so that the user can send instant messages to and receive instant messages from any of the people on the buddy list. The buddy list is created in the instant messenger software resident in the computer and the user adds buddy screen names to it. When the user establishes a connection with the instant messaging server, the client software sends a list of the buddies to the server. The server checks to see if any of the buddies are online, and it continues to do that for as long as the software is being run on the computer. If the user changes the list of buddies during the session, that information is sent to the server as well, so they can keep track of new buddies or ignore buddies that have been deleted from a list. When any of the buddies run the instant messaging software in their computers and login, the client software is told that they are online and the user receives a notice that they are online. The user can now send messages to and receive instant messages from them. When the user sends an instant message, the message goes to the session server which then routes the message to the proper person. Similarly, when there is a response, the message first goes to the server and then to the ultimate destination.

Other instant messaging software, such as those used by Internet portals, enable people to chat directly with each other without having to go through a server. This is, for example, how Yahoo Pager software operates.

Alternatively, a web server 5 can establish a web page that is accessed by computers 2A-2N to carry on a text message chat.

It is therefore desirable and an object of the invention to have a method and system that enables users of text messaging services, such as chat lines and instant messaging, to communicate by voice when desired. People can currently speak to each other from chat rooms, etc., by using low-quality services that involve talking into a microphone on their computer, and listening to other people on their computers' speakers. These systems are difficult to use, unreliable, and have low voice quality. In addition, many of these systems do not support conversations with more than two people, or conversations where two people are talking at the same time.

U.S. Pat. No. 6,148,068, “System for managing an audio conference,” assigned to Nortel Networks Limited (Canada), describes an audio conference system includes an audio telephone connection and a separate network computer connect. In arranging a conference with the audio conference system, a conference time and potential participants are designated. At the conference time, the audio conference system directs the public switched telephone network to place a telephone call to each of the potential participants and sends an invitation to a computer systems associated with the potential participants regarding the audio conference. The potential participants then return an indication of whether they desire to be audio conference participants and computer conference participants. If so, the audio conference system will send each computer participant display data with information about the audio conference including who is participating in the conference. Additional display data may also be included such as documents that are to be discussed during the conference.

U.S. Pat. No. 5,818,836, “Method and apparatus for anonymous voice communication using an online data service,” assigned to Stephen C. DuVal, (Iverness, Ill.), describes an anonymous telephone communication system. The system includes an anonymous voice system which can establish an anonymous telephone communication through a circuit switched network (CSN). In operation, two parties place separate telephone calls to the anonymous voice system through the CSN. The parties then enter matchcodes through their telephone keypads. The anonymous voice system compares the matchcodes entered by the parties and connects the telephone calls if the matchcodes match. The system may include an on-line data service that establishes electronic communication between the parties through corresponding data terminals. The data terminals may have resident anonymous voice input commands that can be selected by the parties. The on-line data service transmits a connect command to the anonymous voice system which dials the two parties, or waits for the parties to dial the system, and then connects the parties. The anonymous voice system sends a disconnect command to the on-line data service when the parties hang up. The disconnect command can be used by the online service to bill the parties for using the anonymous voice service. The system also stores a couple record during the first anonymous call recording the matchcode and the telephone numbers of both parties. Subsequently, either party may initiate an anonymous call to the other party without prior coordination.

U.S. Pat. No. 5,764,916, “Method and apparatus for real time communication over a computer network,” assigned to ichat, Inc., (Austin, Tex.), describes a method for real time network chat, TCP/IP connections are established between a plurality of clients and a host. Respective real time communications protocol connections such as telnet or IRC are established over the TCP/IP connections, and a message is sent from one of the clients to at least one of the other clients through the host using the respective real time communications protocol connections therebetween. The message, which includes one or more instructions in a markup language such as html, for example, is parsed in the receiving chat client, which displays the message in accordance with the markup language instructions contained therein. Where the markup language instruction is a hyperlink, the telnet chat client receiving the message from the host communicates the URL associated with the hyperlink to a Web browser under user control, and the Web browser requests and receives the desired Web document.

One difference between the present invention and the patents cited above is that the present invention allows for anonymous calling. One advantage of the present invention is that the present invention provides a way of conducting anonymous calls generated by interaction in a chat, instant messaging, or online collaborative environment. A second advantage of the present invention is that it can provide spontaneous service, as requested by the participants. A third advantage of the present invention is that it provides a private, secure connection between participants.

It is also desirable and another object of the present invention is to permit users of text messaging services to communicate via voice communication without revealing personal identity information, such as a telephone number.

A main object of the present invention is a system for providing audio conferencing services to users of on-line text messaging services.

Another main object of the present invention is a method of using a system for providing audio conferencing services to users of on-line text messaging services.

A further object of the present invention is to provide users of text messaging services with the ability to set up conference calls with as many participants as desired.

A further object of this invention is to allow people to lock conferences, thereby preventing other people from joining a conference that is underway and preserving the privacy of those who have already joined.

A further object of this invention is to provide payment options that can be chosen by people when they enter the call, with all payment information provided over the telephone.

A still further object of this invention is to allow people to use such services without going through a lengthy sign-up or registration process.

Audio conferencing services allow groups of people to communicate via telephone. Any person with access to a public telephone network can place a call to or receive a call from a centralized audio conferencing network that allows two or more people to talk as if they were in a conference. This is accomplished through the use of a teleconferencing bridge such as an AT&T 5ESS which allows two or more callers to communicate with each other.

Conventional teleconferencing bridges use analog audio conferencing switches that receive an incoming audio signal from one or more callers participating in a conference and send that signal or combined signals of multiple callers to the participants of the telephone conference.

The present invention can utilize conventional bridges as described above or use a VOIP bridge such as the one described in application Ser. No. 09/528,549, filed Mar. 20, 2000 and now pending, the disclosure of which is hereby incorporated by reference.

### SUMMARY OF THE INVENTION

The objects and advantages of the present invention are achieved in accordance with the present invention by a method and system for providing audio conferencing services to users of an online text messaging service who are connected for text messaging over a computer network, preferably a global computer network, and most preferably, over the Internet. The invention is also very useful over intranets and other company/organization internal networks.

In accordance with the present invention, a user may request a conference call from their chat or instant messaging service. The service forwards this request to a conferencing platform which includes a conference bridge, and which allocates and returns a telephone number and one or more numeric access codes. The telephone numbers and access codes are displayed to selected users through one of several methods described below. The users are instructed to call the telephone number using a standard or VoIP telephone and to enter the access code given to them. The call is received at the conferencing platform from at least two of the selected users. The conferencing platform matches the access codes entered by the at least two users, and places them into a conference call. As a result of this system, the selected users can communicate orally over the telephone network without revealing their telephone numbers to the other participants.

The method and system according to the present invention thereby extends instant messenger and chat type services by enabling spontaneous, anonymous, one-to-one and multi-party conversations over the telephone network. No additional hardware, such as microphones and the like, are required.

A first embodiment of the present invention is a system for dial-in teleconferencing, including: a telephone network to which callers are connected; an IP gateway; an IP bridge; connection to a network such as the Internet; an Internet portal, hosting a text messaging server; an Internet service provider, hosting a text messaging session server and a text messaging login server; and, representative network-connected computers A and B, with audio conferencing client software and text messaging client software installed.

A second embodiment of the present invention comprises the first embodiment, with the IP bridge containing elements including: one or more web servers; an IP switch; a switchboard; an SQL database; a scheduler; a resource manager; a call flow manager; one or more call flow units; an Media server unit (MSU) manager; and, one or more media server units.

A third embodiment of the present invention is a method of using a system for dial-in teleconferencing, including the steps: users communicating through text-based instant messaging (IM); requesting audio conference by pressing screen button; entering billing info via secure Internet connection; allocating call by platform on conference bridge; returning instructions returned to client 1; displaying call instructions for client 1; sending call instructions to client 2; displaying call instructions for client 2; enabling call by following instructions; and, conferencing begins.

These and other features of the present invention will become apparent from the following detailed description of invention taken with the drawings.

### BRIEF DESCRIPTION OF THE DRAWINGS

FIG. 1 is a schematic view of known text-messaging and chat systems;

FIG. 2 is a schematic view of an IP bridge system for carrying out the method of the present invention;

FIG. 3 is a schematic view of the flow among text messaging clients, chat servers, telephones, and a conferencing bridge, in accordance with the present invention for carrying out the method of providing audio conferencing services to users of on-line text messaging services according to the present invention;

FIG. 3A shows screen view introductions to the method of the present invention;

FIGS. 4-7 are flowcharts for methods used in accordance with the system and methods according to the invention;

FIG. 8 is a screen shot of host instructions for initial call set-up; and

FIG. 9 is a screen shot of call instructions for an unbilled participant.

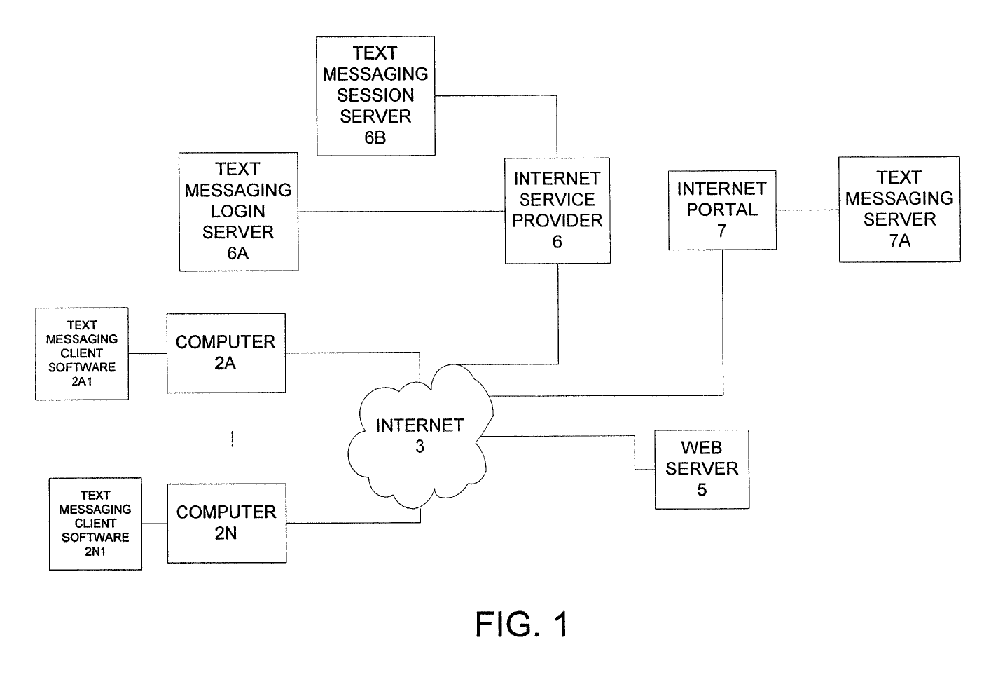

### DETAILED DESCRIPTION OF THE INVENTION

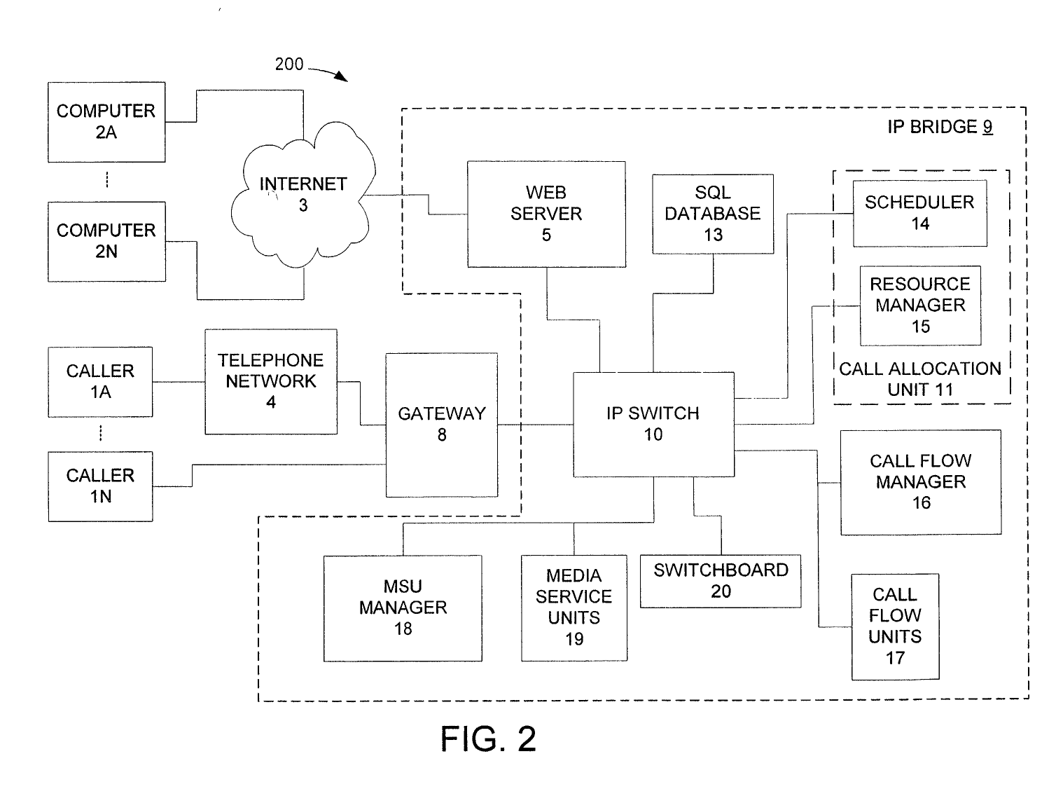

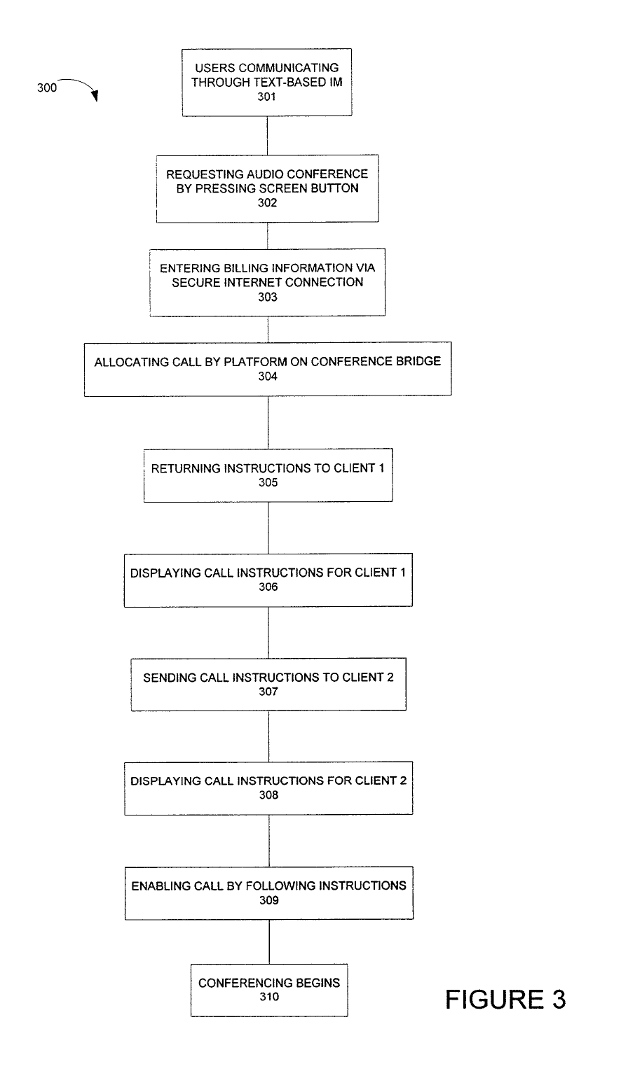

The method and system for providing audio conferencing services to users of an on-line text messaging service will now be described in more detail with regard to FIGS. 2, 3 and 3A.

FIG. 2 illustrates the IP bridge system 200 of the present invention. System 200 includes two or more computers 2A through 2N connected to a network such as Internet 3, and two or more callers 1A through 1N which may either be connected via telephone network 4 (through which calls pass involving a series of transfers not the subject of this invention) or be connected directly to gateway 8. Internet 3 and gateway 8 connect to IP bridge 9, with network communication from Internet 3 passing to (one or more) web servers 5, while telecommunication traffic flows from gateway 8 to an IP switch 10. In addition, IP bridge 9 has elements including a switchboard 20, a SQL database 13, a scheduler 14, a resource manager 15, a call flow manager 16, one or more call flow units 17, a Media server unit (MSU) manager 18, and one or more media server units 19. A call allocation unit 11 is also characterized as an element of IP bridge 9, and is a collective term used to describe scheduler 14 and resource manager 15.

Alternatively, IP bridge 9 can be a conventional bridge or a VOIP bridge such as the one described in application Ser. No. 09/528,549, filed Mar. 20, 2000 and now pending, the disclosure of which is hereby incorporated by reference.

FIG. 2 constitutes enhanced depiction of the general functional elements of IP bridge 9, principally embodied in the addition of scheduler 14 and resource manager 15. In general, scheduler 14 handles the number of participants, the rate and assignee of billing, and the timing specifications of individual teleconferences. Scheduler 14 generates instant access codes used to validate participants in a conference call session in accordance with the invention which is hereinafter referred to as “Buddy Yak”. Scheduler 14 also sets the “lifespan” (the time span over which the codes are valid) of the access codes issued. Resource manager 15 operates as a governor of work to be performed by IP bridge 9 in terms of resource allocation, and determines which system resources to query for help in doing so. Resource manager 15 determines what Buddy Yak access code to assign to a Buddy Yak conference session from a pool of available numbers. This access code then appears on the Buddy Yak chat screen. Resource manager 15 also deallocates the session access code after the session has expired due to time constraints (i.e., the host will only pay for a 30 minute chat) or physical call breaks (i.e., hang-ups).

Further description of the operation of scheduler 14 and resource manager 15 is given with respect to FIGS. 3 and 3A.

FIG. 3A represents basic screen view introductions to Buddy Yak, and representative flows of communication between callers. In scenario A, the caller “Murrien” chooses to continue an active chat session via the telephone by clicking the talk button 201 within the instant messaging application being used. Both “Murrien” (the “host”) and her chat partner “Anderson10” then see pop-up invitation boxes appear on their screens instructing them to call a centralized phone number and enter an assigned access code to initiate a Buddy Yak session.

In scenario B, a single host decides to invite three other participants in an active chat session to a Buddy Yak session. In this case, the host and all chosen participants see pop-up invitation boxes with instructing them to call a centralized phone number and enter an assigned access code to initiate a Buddy Yak session.

FIG. 3 is a flowchart illustrating a method of using system for providing audio conferencing services to users of on-line text messaging services. Method 300 includes the following steps:

Step 301: Users Communicating through Text-Based Instant Messaging (IM)

In this step, two or more users may be communicating using a chat system.

Step 302: Requesting Audio Conference by Pressing Screen Button

In this step, a client (hereafter “client 1”) decides to convert the current text based conversation to a voice communication, the user clicks on a button such as button 201 in FIG. 3A, provided by the instant messaging or chat software being used. Upon clicking on the button, a function call is made to resource manager 15 within call allocation unit 11. This function call may include such information as the identity of the participants in the call, and the number of participants desired.

Step 303: Entering Billing Info Via Secure Internet Connection

In this step, the billable client enters billing information (such as credit card information) using a secure web connection with web server 5. Verisign is used for secure credit card validation over a Secure Socket Layer (SSL) connection, using the HTTPS (Hypertext Transfer Protocol—Secure) Internet standard.

Step 304: Allocating and Reporting Call by Platform on Conference Bridge

In this step, scheduler 14 within call allocation unit 11 generates access codes and access telephone numbers, and registers these with the call management subsystem of the conferencing platform. This initiates the capture of reporting and billing information for Buddy Yak sessions, as generated by call allocation unit 11. Buddy Yak's interactive voice response (IVR) system logs data to SQL database 13 in the form of a Call Detail Reporting (CDR) log. CDR log entries should include:

Application ID (e.g., Odigo or Delphi)

Application Category ID (e.g., chat, IM)

Screen Name of caller, if available

Screen Name of call initiator, if available

Type of call (host pays, participants pay)

Payment Method

ANI, if available

Account number that can be retrieved from payment method (ANI or Credit Card number)

Call start time

Call end time

Subsequently, available reports should include:

Number of calls and total minutes of use by partner per hour, per day, per week, and per month during the reporting period.

Average call size and duration by partner during each hour/day/week/month during the reporting period.

Number of legs sorted by duration and partner during each hour/day/week/month during the reporting period.

Summary information sorted by call type (host pays, participants pay).

Call detail report for every call during the reporting period. The detail should include the start time, end time, the peak number of users on the call, and total minutes of use, total charge per participant, total charge for the call, and type of call (host or participants pay). Users are identified according to screen name or other identifying code provided by partner.

Number of accounts that were uncollectable for having calls totaling less than $0.80 and over 60 days old.

Number of accounts that are pending to be collected for having calls totaling less than $0.80 but less than 60 days old.

Percentage of ANIs that go bad during each hour/day/week/month during the reporting period.

Step 305: Returning Instructions Returned to Client 1

In this step, the access codes and access telephone numbers are returned from IP bridge 9 to client 1, as the result of the function call.

Step 306: Displaying Call Instructions for Client 1

In this step, display calling instructions to client 1.

Step 307: Sending Call Instructions to Client 2

In this step, send the call instructions to requested chat participant (hereafter “client 2”). These instructions may be forwarded directly to client 2 over the Internet or other network, or they may be forwarded through the chat server or instant messenger server, depending on the design of chat system or instant messenger system in use.

Step 308: Displaying Call Instructions for Client 2

In this step, display calling instructions to client 2.

Alternatively, steps 306 and 307 can be performed manually, rather than automatically by client 1. That is, client 1 can manually send the calling instructions to client 2 and other users by cutting and pasting the text of the instructions into the chat client, into an e-mail message, for example. Clients 1 and 2 then call into the conferencing platform in either order, by dialing the telephone access numbers displayed to them as assigned by scheduler 14.

Step 309: Enabling Call by Following Instructions

In this step, audio instructions prompt the clients to enter the assigned access code. The access codes are recognized by the call management system, which places the two parties into the call using the call flow manager 16.

Step 310: Conferencing Begins

At this point, client 1 and client 2 may talk on the phone without previously sharing personal identifying information in the course of setting up the call.

In the scenarios above, the chat is taking place between two participants. Clearly, the same functionality could be provided with more than two participants in the chat, and hence more than two participants in the call.

Chat rooms, instant messaging sessions, web collaboration sessions, etc, often include many people. It may be that a client wants to engage in a voice conversations with fewer than all of these many people. In such a case, the client would select the names of the desired voice participants, by highlighting them or otherwise indicating them in the tool before clicking the “talk button”. Call access information would only be sent to the selected participants.

A variation of the steps, above, has the call allocation unit of the conferencing platform displaying call instructions directly to client 1 on a web page displayed to client 1, rather than returning the instructions to the chat client 1 for display to client 1. Alternatively, the users can have client software that is used to display the call instructions.

The call allocation unit and call management unit of the conferencing platform comprise programmed computers and can be embodied in separate computers or in a single computer. The call management unit comprises a conference bridge. The call allocation unit receives the request for the call, including the names, screen names, or other identifiers for zero or more of the call participants and optionally receives the number of participants.

In response to the call request, the call allocation unit registers a conference call within the system, including the following information: a unique conference ID; one or more access codes; and possibly other information, such as billing methods and the maximum number of people to participate in the call.

If more than one access code is allocated, these access codes are used to identify the different participants in the call. That is, the allocation system associates each access code with one of the potential participants, and arranges for that participant to see that access code. When participants dial in and enter the access codes, the call management unit can use the access codes to identify which of the several participants is calling. This information can be used for reporting, for call control (displaying who is on the call), or for billing (charging different amounts to different participants, etc).

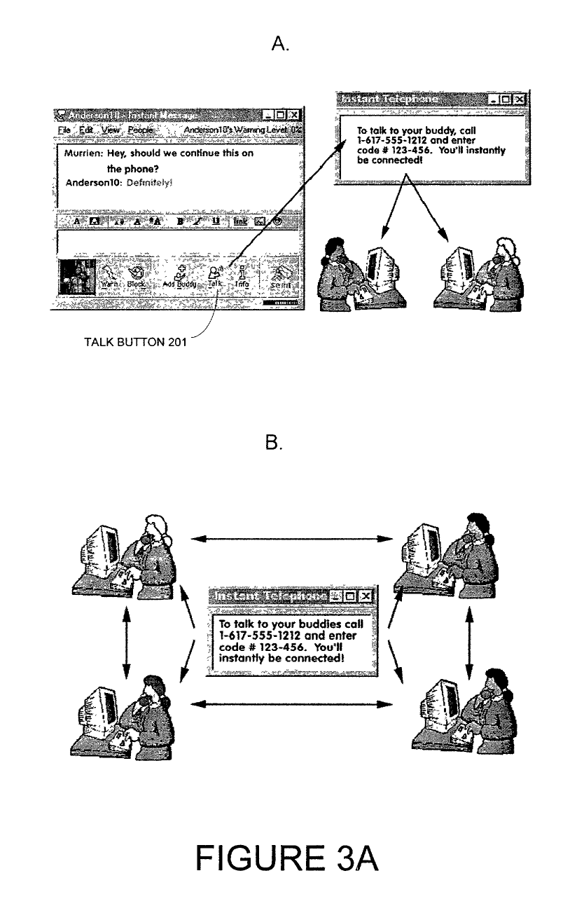

FIGS. 4-7 show the IVR's for all of the flows in the conference bridge platform that eventually connect the participants by telephone.

As shown in FIG. 4, in step 400, the caller dials the 800 number or the long distance number to reach a conference. The caller is prompted in step 401 with a welcoming message and in step 402, requests the buddy number. In step 403, the type of call is determined, that is, whether it is a “participant pays” or a “host pays” call. In a “host pays” call, the person who initiates the conference pays the per-minute costs for all participants. In a “participants pay” call, each participant pays the per-minute fee for their own usage. If it is a host pays call, in step 404, the type of caller is determined, that is, whether it is the host or participant. The caller type can be determined for example by prompting the caller to key in a response to identify the call type. If it is a participant, the caller then is prompted with a message in step 405 indicating the minimum age to the use service. In step 406, it is then determined whether the host is present. If the host is not present, the user is prompted with a message in step 407 that the caller will now have to hold. In step 408, it is determined whether the host has become present during a waiting time of, for example, one minute. If the host is still not present, the user is prompted in step 409 that the host has not arrived, and the user is asked to call later, and in step 410, the caller is disconnected.

Referring back to step 404, if the caller is the host, the host is prompted in step 412 as to the cost of the service, and the host then has the choice in step 413 of selecting a billing option.

If the type of call is a participant pays call, after step 403, the caller is directed to a prompt in step 411 indicating the cost of the service, and the caller then is directed to step 413 where a billing option is selected. Returning back to step 406, if the host was present, then the caller is directed to step 414 from step 406. Likewise, all callers who have reached the select billing option step 413 are connected to step 414. In this step, the caller is prompted to press the << << at any time to receive the terms of service and other menu options. In step 415, the caller is prompted about the entry into the conference, in step 416, a call entry tone is issued so that others in the conference know that someone has been added, and in step 417, the caller is placed into the conference.

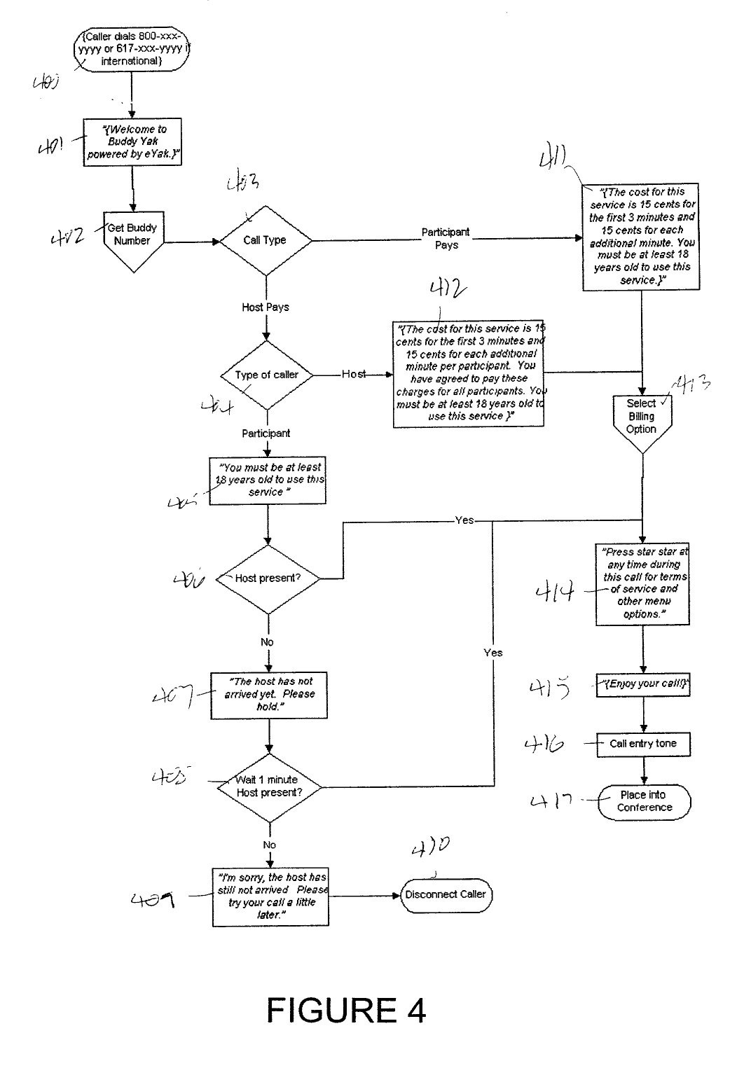

FIG. 5 illustrates the steps related to getting the buddy number in step 402 in FIG. 4. In step 500, the system will obtain the buddy number by first prompting the caller in step 501 to enter the buddy number shown on the screen on the keypad of the telephone followed by the # sign. In step 502, the system determines whether the buddy number is present in the database. If not, the system goes into an error loop in step 503 indicating to the user that the number is not recognized and asking the user to continue to try to enter the proper number. After three tries, the call is terminated.

If the proper buddy number is presented, in step 504, the system determines whether the call limit has been reached for that group. For example, a call limit could be twenty callers in a group. If yes, the caller is prompted with a message in step 507 that the call is full, and the caller is disconnected in step 509. If the call limit has not been reached, then the system determines if the call has been locked in step 505. If yes, the user is prompted in step 508 of this fact, and the caller is disconnected in step 509. If the call has not been locked, the system allows the user to proceed in step 506.

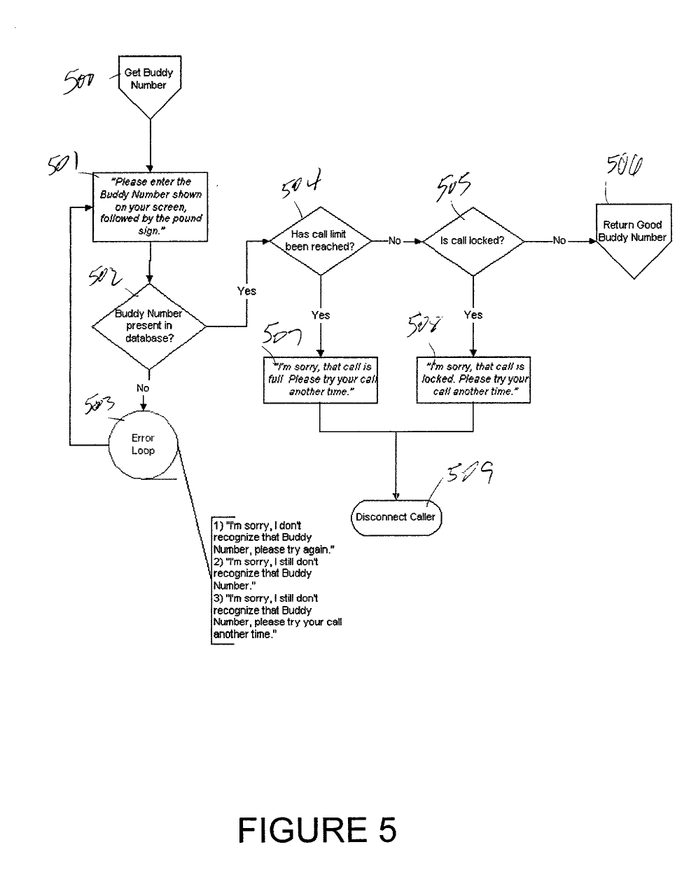

FIG. 6 illustrates the select billing option step 413 in FIG. 4.

The billing option selection in step 600 first checks to see if there is a billable telephone number (good ANI) in step 601. This phone number can be automatically detected and tested by the conferencing bridge. If there is no good ANI, the user is prompted in step 602 that the charges cannot be made to the phone bill but can still made by credit card. The user is then prompted in step 603 to enter a credit card followed by the # sign. In step 604, the user is prompted to enter the expiration date, and in step 605, the credit card is or is not validated. If not, an error loop is entered in step 606 which tries to obtain the proper credit card information, but if it does not, terminates the call. If the credit card is validated, the user is returned with a billing O.K. back into the method of FIG. 4 in step 612.

If the ANI is good, the user is directed to step 607 where it is determined whether the ANI credit limit has been reached. If yes, the user is prompted in step 608 that the credit limit has been reached and allows the user to either press the number 1 and make a credit card call feeding it into step 603, or if the user presses a request to increase the credit limit, the user is transferred to the credit representative in step 609.

If the credit limit was not reached, the user is prompted in step 610 to either pay by credit card or on the telephone bill. If the user selects credit card, the user is directed to step 603. If the user selects to pay by telephone bill, the user is prompted in step 611 thanking the user and returning the user to the method of FIG. 4 in step 612.

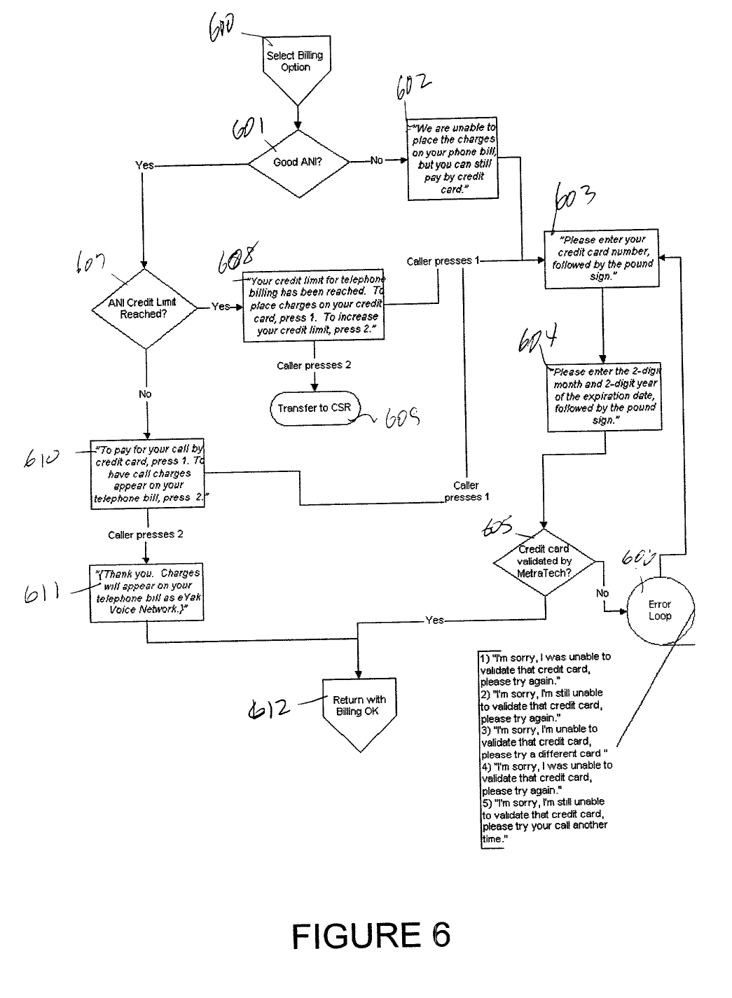

FIG. 7 shows the steps of in-call options after step 417 in FIG. 4. In step 700, which is within the call, the user has the option of pressing << << in step 701 to receive a menu of options, including locking or unlocking the call or speaking to a customer representative. If the user presses the wrong choice, the user is sent to an error loop 704 where different prompts are given to obtain the proper response. If the user presses the <<4 key in step 702 or presses 4 in response to the options given in step 703, the user is directed to step 706 where it is first determined if the call is locked. If the call is not locked, then the user is prompted in step 705 that the call is now locked and instructed as how to unlock calls. If the call is locked, the user is prompted in step 707 but the call is now unlocked and instructions are given as to how to lock it again. In steps 705 and 707, this message is also played to the entire conference.

If in step 703 the user presses 0 to speak to the customer service representative, the user is prompted in step 711 to wait and hold for a customer service representative, and the user is transferred to that customer service representative in step 708. If in response to step 703 the caller presses the # key or does nothing for a given time, the user receives a call entry tone in step 709. This entry tone is also received after steps 705 and 707. Thereafter, the user is returned to the conference in step 710.

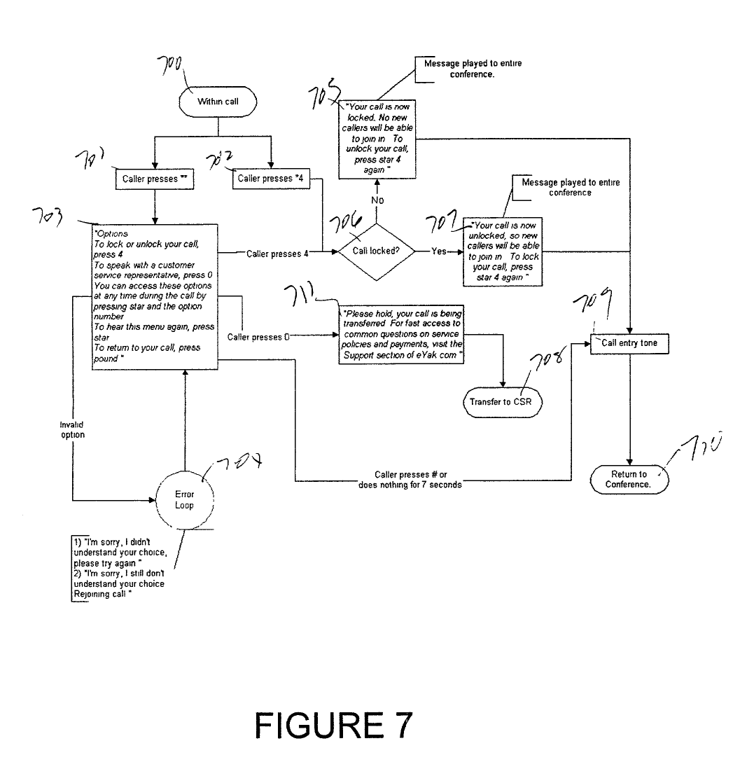

FIG. 8 is an example of host instructions for establishing a call. These representative instructions correspond to that seen when, for example, talk button 201 is clicked in an instant messenger application to initiate a Buddy Yak session. In the case of the above example, once a call is placed and the Yak Number has been entered by the caller, the host will be billed at the listed rate for the total time spent by participants in the Buddy Yak session. Other forms of billing sessions (i.e., all participants pay) are also available.

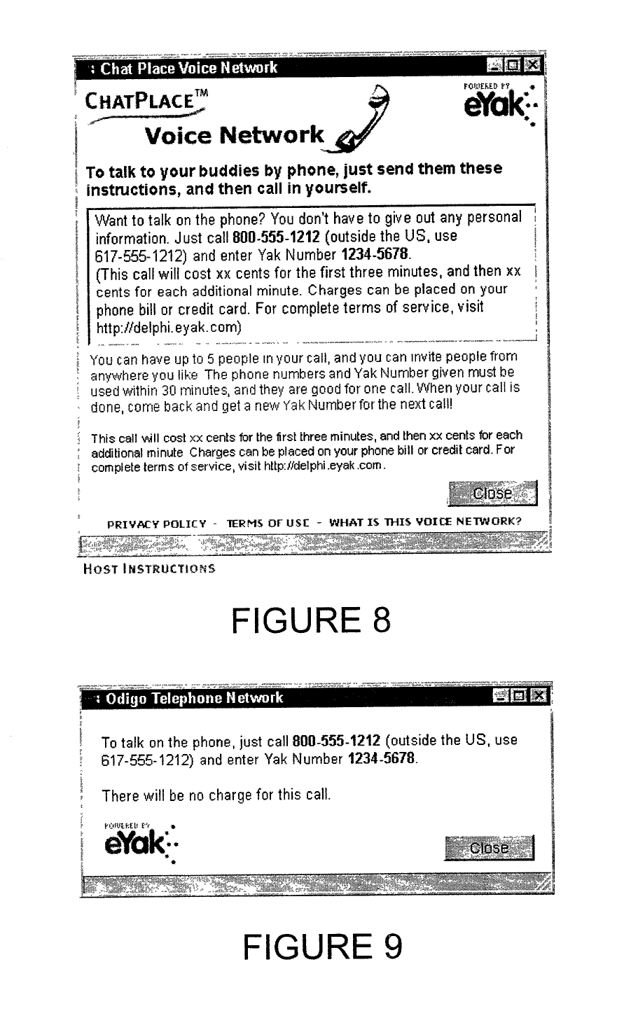

FIG. 9 is an example of call instructions for an unbilled participant. The above representation of participant instructions corresponds to that seen when someone is invited to a Buddy Yak session for which he or she will not be charged. In this example, the invitee must simply call the telephone number listed and when prompted enter the Yak Number to be connected at no charge to the Buddy Yak session.

The present invention can be distributed through companies that provide instant messengers, chat software and services and online collaboration tools. Any tools that bring people together on the Internet in real time can be supplemented to bring people together on the telephone. Commercial users include office workers who regularly communicate and/or collaborate with coworkers, clients and service providers at other sites. These users can take advantage of the group calling, spontaneity and simplified billing components of the present invention. Home users of instant messaging and chat software who regularly communicate with friends and friendly strangers on the Internet. These users will have the advantage of the privacy protection, group calling and spontaneity and simplified billing that is achieved in accordance with the present invention.

The method according to the present invention can be used by office users for last minute audio conferences, regularly scheduled audio conferences, team meetings and updates and spontaneous collaboration. Home users can use the method for family phone calls, audio support for games, special interest discussion groups, meeting new people and getting to know an online friend better.

The present invention can use several different billing methods, including credit card billing which places charges for calls on one's credit cards. Alternatively, there can be local exchange carrier billing which places the charges on the dialing telephone number.

The present invention provides for a simple and spontaneous audio conferencing service with no planning, setup or registration required. It supports one-on-one, as well as group conversations, and it preserves the anonymity of all participants by having them call into the central number to connect. Callers can access the service through toll free and direct dial telephone numbers and pay for it on their local telephone bill or by credit card.

Calls can be set up in real time over the Worldwide Web. Calls can be scheduled to take place immediately or at a set time during the current or following day. The call initiator has the option of paying for the entire call or having each participant pay for their portion of the call. The call initiator receives calling instructions, including toll free and direct in dial telephone numbers and a buddy number access code. The call initiator can then share these instructions with the other callers over the instant messaging service, a chat line, etc. An alternate interface allows all participants to receive calling instructions directly with support from the hosting instant messenger, chat, collaboration client. Each buddy number can be used for one call. To make additional calls, users must provide another conference. Buddy numbers will also preferably expire if they are not used within, for example, thirty minutes of the scheduled time.

After providing for a call and at the scheduled time, all participants access the call by dialing the toll free or direct in dial number. Incoming calls are intercepted by an IVR that asks the participant to enter their buddy number access code. For participant-pay calls, everyone will be added in immediately when they dial in. For host-pays calls, participants will only be added once the host arrives. Participants who dial in prior to the host are played an explanatory message and placed on hold. After one minute, they are instructed to call back at a later time and are disconnected. If the maximum number of participants for the conference has been reached, the participant will hear a message informing that potential participant that they cannot join the conference in progress.

Call setup is accomplished through a simple HTTP interface or through a simple C/C++ or Java programming language function call. The invention is preferably carried out using Windows 95, Windows 98, Windows NT or the Windows 2000 platform.

Any caller has the ability to lock a conference by pressing an appropriate button on the telephone keypad. When a conference is locked, no other participants can call in. A message is played to the entire conference noting that it is locked. Any caller can unlock a conference by pressing another specific key on the telephone keypad. A similar message is played to the entire conference noting that it has now been unlocked.

It is understood that the embodiments described hereinabove are merely illustrative and are not intended to limit the scope of the invention. It is realized that various changes, alterations, rearrangements and modifications can be made by those of skill in the art without substantially departing from the spirit and the scope of the present invention.

What is claimed is:

1. A method of providing audio conferencing services to users of an on-line text messaging service connected for text messaging over a computer network, the method comprising the steps of:
receiving a request from a on-line text messaging client to set up a conference call;
allocating a telephone number and access code for the conference;
providing said telephone number and access code to selected users and instructing the selected users to call the telephone number using a telephone network and enter the access code; and
receiving telephone calls from users and identifying them by the access codes they enter and joining the users in an audio conference.

2. The method according to claim 1, wherein the users choose a billing option when they call said telephone numbers.

3. The method according to claim 1, wherein the users do not reveal personal information to other users.

4. The method according to claim 1, wherein the access codes are spontaneously generated.

5. The method according to claim 1, further comprising alternatively locking and unlocking an audio conference to prevent or allow additional callers to join an audio conference.

6. The method according to claim 1, wherein the step of receiving comprises providing a button on the display of and wherein in response to one user clicking the button, dialing out to the other selected users.

7. The method according to claim 1, wherein the step of providing the telephone number and identification code comprising displaying same on the computer screen of each selected user.

8. The method according to claim 1, wherein the audio conferencing service is operative at the same time as the text messaging service.

9. The method according to claim 1, wherein the step of providing comprises sending the telephone number and identification code via email.

10. The method according to claim 1, wherein the step of providing comprises returning the telephone number and access code to the selected users.

11. The method according to claim 1, wherein the step of providing comprises displaying the telephone number and access code on the display of the selected users.

12. The method according to claim 1, wherein the online text messaging client comprises one of a chat client, an instant messaging client, and an on-line tool.

13. A system for providing audio conferencing services to users of an on-line text messaging service connected for text messaging over a computer network, comprising:
a server for receiving a request from a on-line text messaging client to set up a conference call; and
a conferencing platform for allocating a telephone number and access code to access the conferencing platform, the server providing said telephone number and access code to selected users and instructing the selected users to call the telephone number using a telephone network and enter the access code; and
wherein the conferencing platform receives telephone calls from users and identifies them by the access codes they enter and joins the users in an audio conference.

14. The system according to claim 13, wherein the users choose a billing option when they call said telephone numbers.

15. The system according to claim 13, wherein the users do not reveal personal information to other users.

16. The system according to claim 13, wherein the access codes are spontaneously generated.

17. The system according to claim 13, further comprising the conferencing platform alternatively locking and unlocking an audio conference to prevent or allow additional callers to join an audio conference.

18. The system according to claim 13, wherein the server provides a button on the display of and wherein in response to one user clicking the button, the conferencing platform dials out to the other selected users.

19. The system according to claim 13, wherein the server provides the telephone number and identification code by displaying same on the computer screen of each selected user.

20. The system according to claim 13, wherein the audio conferencing service is operative at the same time as the text messaging service.

21. The system according to claim 13, wherein the server provides the telephone number and access code by sending the telephone number and identification code via email.

22. The system according to claim 13, wherein the server returns the telephone number and access code to the selected users.

23. The system according to claim 13, wherein the server displays the telephone number and access code on the display of the selected users.

24. The system according to claim 13, wherein the online text messaging client comprises one of a chat client, an instant messaging client, and an on-line tool.
